(19) United States
(12) Patent Application Publication
(10) Pub. No.: US 2004/0108703 A1
(43) Pub. Date: Jun. 10, 2004

(54) Folding ergonomic wheel apparatus

(76) Inventor: David L. McGrew, Malvern, PA (US)

Correspondence Address: Richard C. Litman, LITMAN LAW OFFICES, LTD., P.O. Box 15035, Arlington, VA, 22215, US

(21) Appl. No.: 10/726,497

(22) Filed: Dec. 4, 2003

Related U.S. Application Data
(63) Continuation-in-part of application No. 10/309,215, filed on Dec. 4, 2002.

(51) Int. Cl. B60S 9/02

(52) U.S. Cl. 280/763.1

(57) ABSTRACT

A manual cranking apparatus for the landing gear of a semi-trailer. The cranking apparatus includes a rotatable mechanism that is permanently connected to the cross-shaft of the landing gear. The rotatable mechanism is adapted to be folded such that, in storage position, the mechanism is positioned beneath the trailer.

### CROSS-REFERENCE TO RELATED APPLICATIONS

This application is a continuation-in-part of application Ser. No. 10/309,215 (Attys. Docket no. 21772.00) filed Dec. 4, 2002.

### BACKGROUND OF THE INVENTION

1. Field of the Invention

The present invention generally relates to support devices. More specifically, the present invention is drawn to a mechanical device for raising and lowering the landing gear on a semi-trailer.

2. Description of the Related Art

Usually, a semi-trailer is loaded and unloaded in free-standing position (unattached to the cab). Landing gear must be lowered to support the semi-trailer in this free-standing position. The landing gear must be raised when the trailer is reattached to the cab. In most instances the landing gear is raised and lowered by manipulating a hand crank. Hand cranking requires that the operator bend over to rotate the crank. This scenario increases the potential for back strain and requires an inordinate amount of repetitive muscular exertion. Manually turning the landing gear crank is the second highest cause of injury, lost work time and worker's compensation expense for truck drivers. Ergonomics is the science of fitting the physical demands of the job to the worker to reduce or eliminate repetitive motion injuries that can lead to such disorders as tendonitis, repetitive stress syndrome and back problems. There are more than one million such injuries annually according to the National Academy Of Science. A manual cranking apparatus, which apparatus would reduce the potential for muscular-skeletal injury and provide for more efficient torquing would certainly be a welcome addition to the art.

There is a plethora of devices in the related art for raising and lowering landing gear sans hand cranks. For example, U.S. Pat. No. 4,466,637 (Nelson), U.S. Pat. No. 6,224,103 B1 (Hatcher) and U.S. Pat. No. 6,260,882 (Kingsbury) employ electric motors to raise and lower the landing gear.

U.S. Pat. No. 4,402,526 (Huetsch), U.S. Pat. No. 5,451,076 (Burkhead) and U.S. Pat. No. 5,911,437 (Lawrence) utilize pneumatic actuators, while U.S. Pat. No. 4,928,488 (Hunger) provides a hydraulic actuator to raise and lower the landing gear.

All of the systems disclosed in the above-cited references require a substantial amount of refitting to existing trailers, which refitting would entail a large expense. Furthermore, all the systems are relatively complicated and would require relatively extensive and costly maintenance.

None of the above inventions and patents, taken either singularly or in combination, is seen to disclose a folding, ergomnomic wheel apparatus for raising and lowering landing gear as will subsequently be described and claimed in the instant invention.

### SUMMARY OF THE INVENTION

The present invention is a manual cranking apparatus for raising and lowering the landing gear of a semi-trailer. In one embodiment, the cranking apparatus includes a spoked wheel that is permanently connected via an articulating shaft to the operating cross-shaft of the landing gear. The articulating shaft is arranged to allow the apparatus to be folded such that, in storage position, the wheel is positioned beneath the trailer. In use, the apparatus is unfolded so that the diametric plane of the wheel is parallel to the side of the trailer. When unfolded, the wheel is positioned at a height that enables the operator to assume an erect posture, thereby reducing the potential for back strain. The use of a wheel to rotate the cross-shaft permits a more efficient application of torque.

In a second embodiment the wheel is eliminated and a handle is utilized to raise and lower the landing gear. The second embodiment includes a ratcheting mechanism for economizing the effort needed to raise the gear.

Accordingly, it is a principal object of the invention to provide an improved manual cranking apparatus for the landing gear of a semi-trailer.

It is another object of the invention to provide an improved manual cranking apparatus, which apparatus allows a user to assume an erect posture when operating the apparatus.

It is a further object of the invention to provide a manual cranking apparatus, which apparatus can be folded and stored beneath the semi-trailer.

Still another object of the invention is to provide a manual cranking apparatus, which apparatus employs a spoked wheel or a ratcheting mechanism to enhance tourqing efficiency.

It is an object of the invention to provide improved elements and arrangements thereof for the purposes described which are inexpensive, dependable and fully effective in accomplishing their intended purposes and are generally compatible with all existing semi-trailer landing gear models.

These and other objects of the present invention will become readily apparent upon further review of the following specification and drawings.

### BRIEF DESCRIPTION OF THE DRAWINGS

FIG. 1 is an environmental, perspective view of a folding ergonomic wheel apparatus in storage position according to the present invention.

FIG. 2 is an environmental, perspective view of a folding ergonomic wheel apparatus in an extended in-use position according to the present invention.

FIG. 3 is a top view of the wheel apparatus in an extended position according to the present invention.

FIG. 4 is a perspective view of the wheel apparatus in folded storage position according to the present invention.

FIG. 5 is a perspective view of a second embodiment of an ergonomic landing gear raising and lowering apparatus in an extended in-use position according to the present invention.

FIG. 6 is perspective view of a second embodiment in storage position according to the present invention.

Similar reference characters denote corresponding features consistently throughout the attached drawings.

### DETAILED DESCRIPTION OF THE PREFERRED EMBODIMENTS

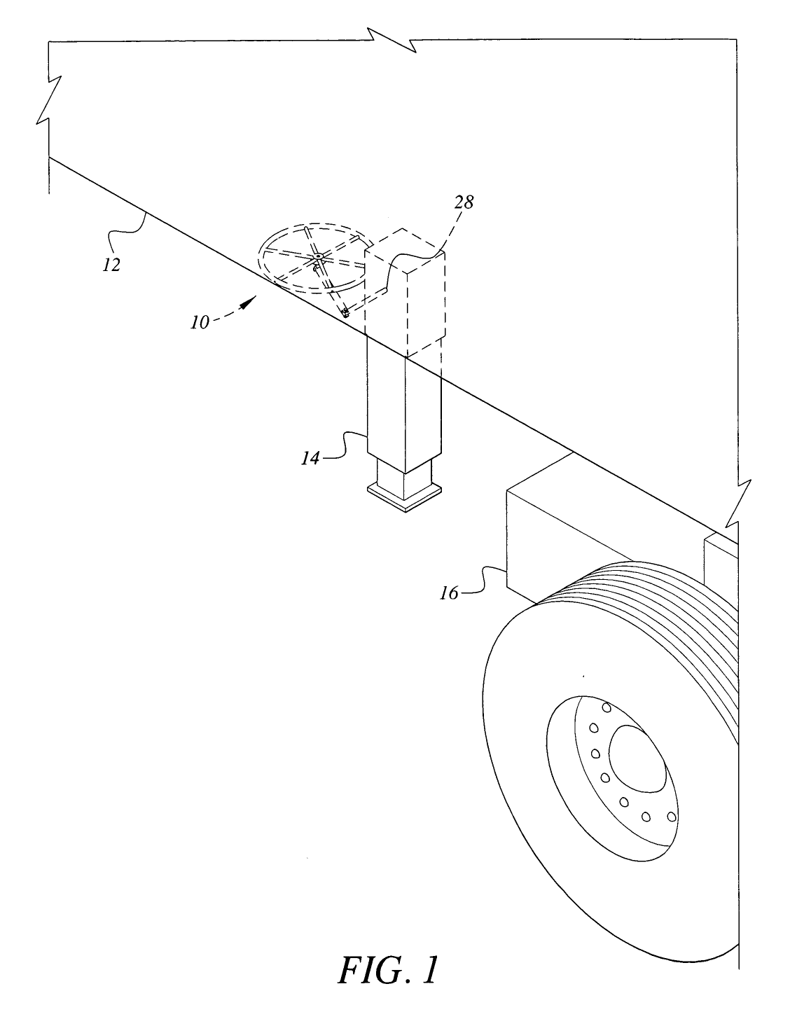

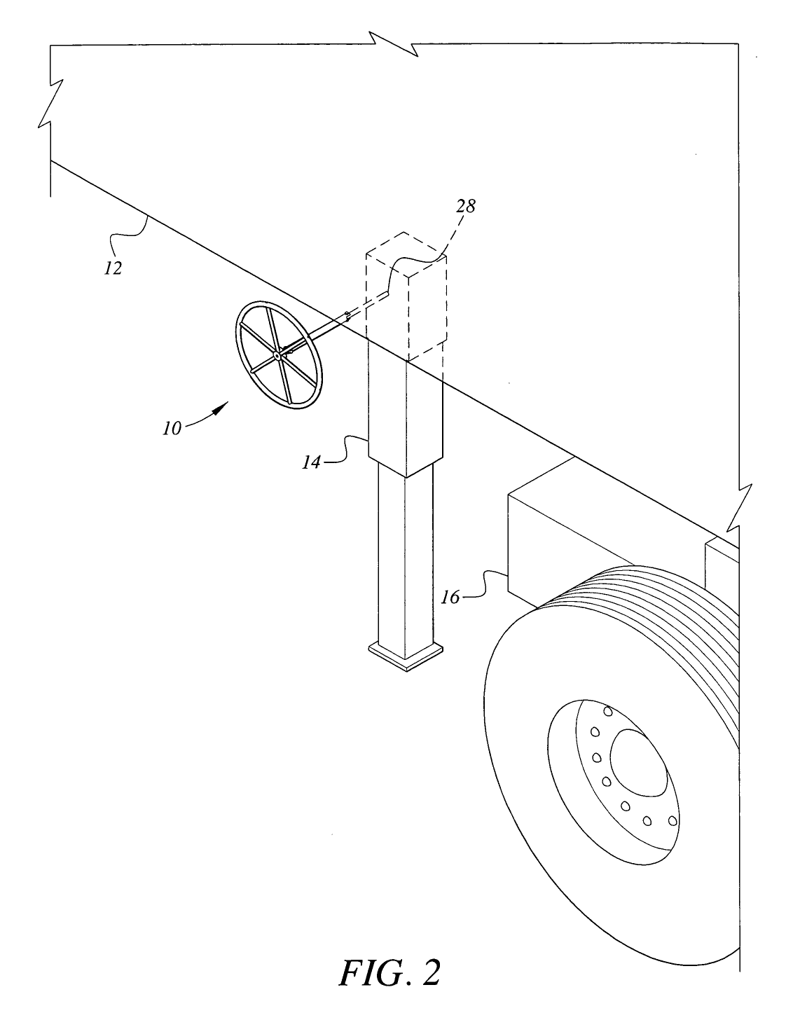

Attention is first directed to FIGS. 1 and 2 of the drawings wherein the folding, ergonomic, raising and lowering apparatus of the present invention is generally indicated at 10. As shown in FIG. 1, apparatus 10 is depicted in a collapsed or folded position and is stored beneath the body of semi-trailer 12 adjacent to landing gear 14. In FIG. 2, the apparatus 10 is depicted in an extended in-use position before the cab 16 is driven away.

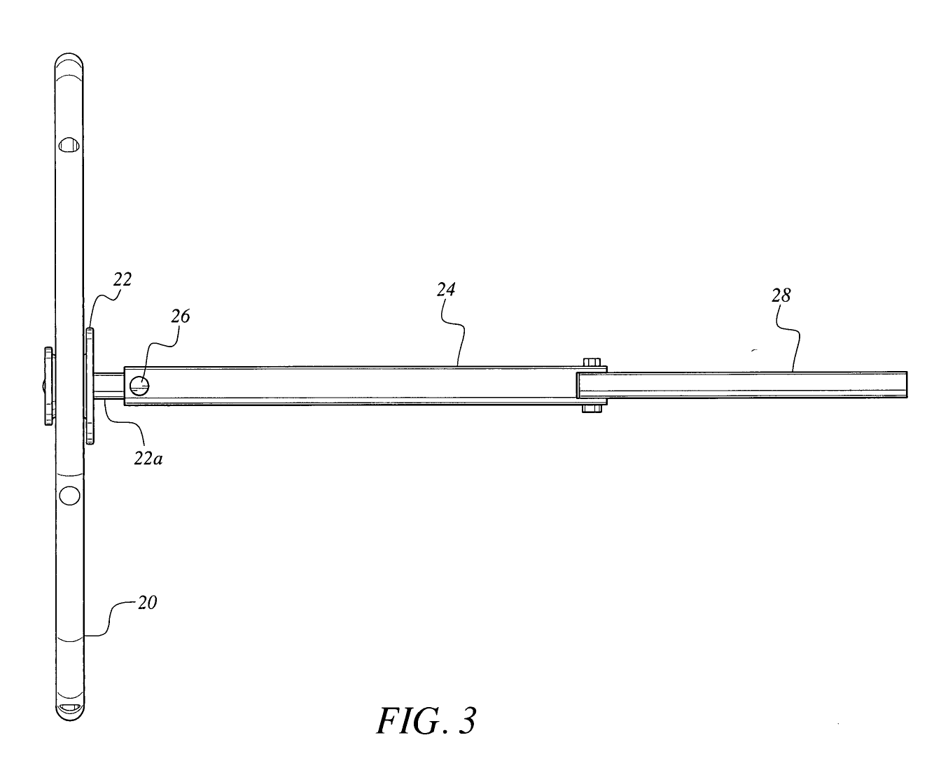

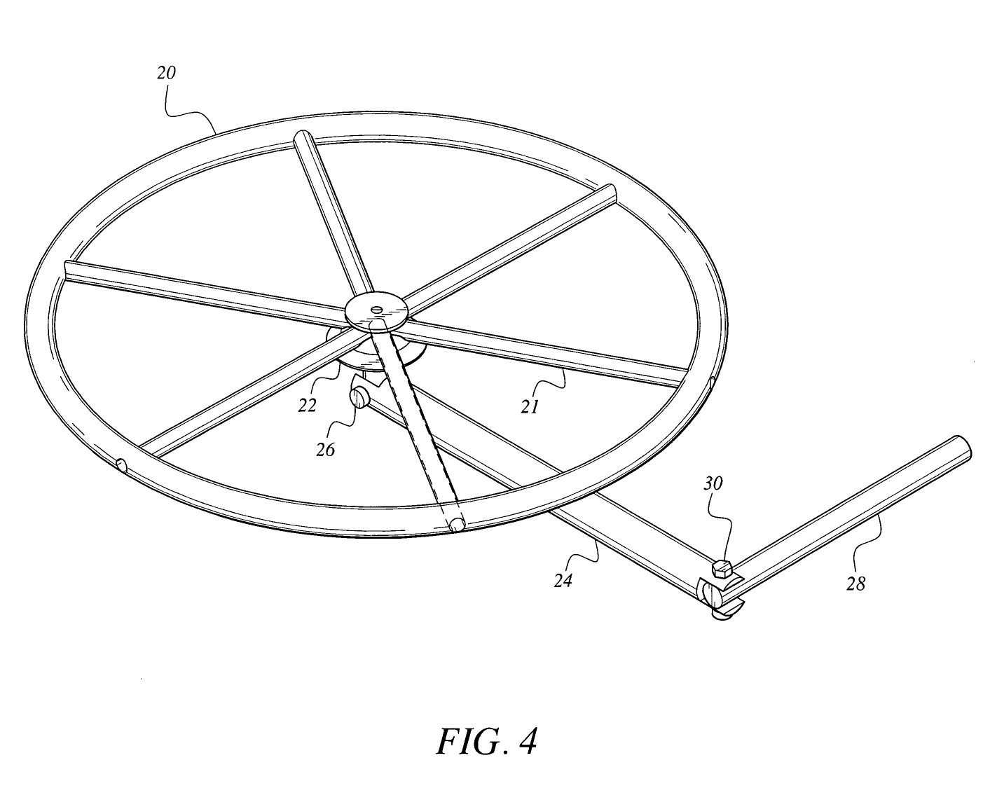

As best seen in FIGS. 3 and 4, apparatus 10 comprises a spoked wheel 20 having a central hub 22 and stub 22a. The spokes 21 of the wheel are hollow and open at the rim of the wheel for purposes as will be explained below. A shaft 24 is articulately attached at a proximate end to stub 22a. A hinge 26 having a ninety-degree range of movement about its axis is employed to effect the attachment. The distal end of shaft 24 is attached to the cross-shaft 28 of the landing gear via a hinge 30, which hinge enables a one-hundred-eighty degree range of movement about its axis. The axis of hinge 26 is perpendicular to the axis of hinge 30. Landing gear 14 and cross-shaft 28 are conventional and are not, per se, a part of the inventive concept. In use, rotation of wheel 20 in one direction will raise the landing gear. When the wheel is rotated in the opposite direction the landing gear will be lowered. Although metal is preferred, wheel 20 and shaft 24 may be fabricated from any suitable, durable material. If necessary, a rod(s) may be inserted into the hollow spokes to extend the effective diameter of the wheel and thereby enhance the torquing leverage. It is contemplated that the spokes of the wheel may be telescopic (not shown) so that the diameter of the wheel may varied. The wheel may also take a multi-sided shape to better enable the usability of the hollow spokes. These arrangements would allow for customized applications to increase or decrease the torque needed to turn the wheel during the raising or lowering process. The hinges may be provided with conventional, easy-release locking structure whereby to lock the hinges in the in-use position.

As described above, the hinge arrangement permits the wheel to be folded for storage (FIG. 1) when not in use and extended to an in-use position (FIG. 2) whereby a user can raise and lower the landing gear without bending or stooping.

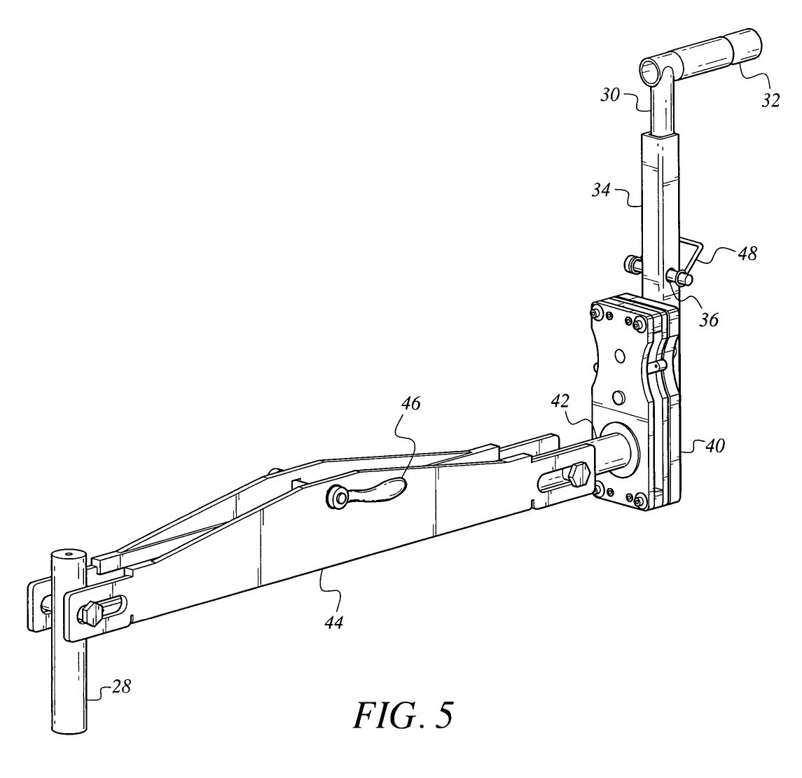

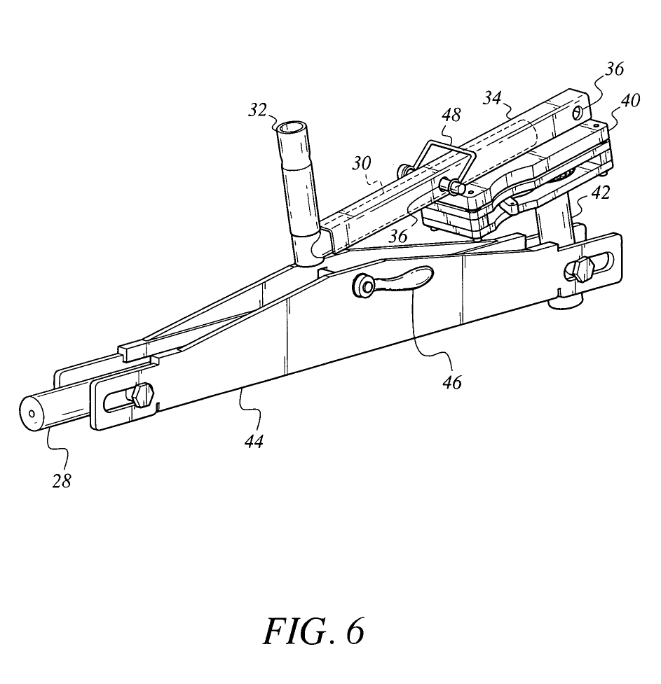

Attention is now directed to FIGS. 5 and 6 wherein a second embodiment of the apparatus is illustrated. The second embodiment employs an arm 30 nested within a U-shaped channel 34 and extendable therein. A handle member 32 is disposed at one end of arm 30 and extends perpendicularly therefrom. Openings 36 (only one shown) are respectively provided along the length of the arm and the channel for purposes as will be explained below. A ratchet mechanism 40 is attached at its front face to the rear surface of the channel. A hub 42 extends from the rear face of the ratchet mechanism and is coupled to the cross-shaft 28 of the landing gear via a flanged coupling 44. A compression mechanism 46 may be employed to compress the flanges about the cross-shaft 28 if needed. A locking pin and bale assembly 48 is inserted through corresponding openings 36 to secure the arm in the channel in the desired extended position. Self-locking security bolts 38 are utilized to provide for secure pivoting and locking.

It is to be understood that the present invention is not limited to the embodiments described above, but encompasses any and all embodiments within the scope of the following claims.

I claim:

1. In combination with a semi-trailer having an exterior side, an undersurface and landing gear, wherein said landing gear has a cross-shaft, an apparatus for raising and lowering said landing gear, said apparatus comprising:
a rotatable member, said rotatable member attached to said cross-shaft for rotating said cross-shaft in a first direction to raise said landing gear and for rotating said cross-shaft in a second direction to lower said landing gear; and
a flanged coupling connecting said rotatable member to said cross-shaft, whereby said rotatable member can be collapsed to assume a storage position beneath said undersurface and extended to an in-use position adjacent said exterior side.

2. The combination as recited in claim 1, wherein said rotatable member includes a U-shaped channel and an arm member nested and extendable within said U-shaped channel.

3. The combination as recited in claim 1, wherein said rotatable member includes a hub mounted for pivoting movement to said flanged coupling.

4. The combination as recited in claim 1, wherein said rotatable member includes a ratchet mechanism.

5. The combination as recited in claim 1, wherein said flanged coupling is mounted to said cross-shaft for pivoted movement thereon.

6. In combination with a semi-trailer having an exterior side, an undersurface and landing gear, wherein said landing gear has a cross-shaft, an apparatus for raising and lowering said landing gear, said apparatus comprising:
a ratchet mechanism, said ratchet mechanism having a front face and a rear face;
a hub, said hub having a first end and a second end, said first end being attached to said rear face of said ratchet mechanism;
a flanged coupling, said flanged coupling having a first end and a second end, said second end of said hub being pivotally connected to said first end of said flanged coupling, said second end of said flanged coupling being pivotally connected to said cross-shaft; and
a U-shaped channel, said U-shaped channel being attached to said front face of said ratchet mechanism.

7. The combination as recited in claim 8, an arm member nested and extendable within said U-shaped channel.

8. The combination as recited in claim 7, including a handle extending perpendicularly from said handle.

9. The combination as recited in claim 8, wherein said arm member and said U-shaped channel include plural openings along the lengths thereof.

10. The combination as recited in claim 8, including a locking pin and bale assembly adapted for insertion in respective ones of said plural openings, whereby said arm member is secured in a desired extended position.

11. The combination as recited in claim 8, including a compression mechanism disposed on said flanged coupling.
